(19) United States
(12) Patent Application Publication
(10) Pub. No.: US 2011/0113024 A1
(43) Pub. Date: May 12, 2011

(54) IMPLEMENTING A GOOGLE-LIKE-SEARCH IN A WEB APPLICATION

(76) Inventor: Jurgen Van Gucht, Grimbergen (BE)

(21) Appl. No.: 12/706,772

(22) Filed: Feb. 17, 2010

Related U.S. Application Data
(62) Division of application No. 12/614,394, filed on Nov. 7, 2009.

(51) Int. Cl. G06F 17/30; G06F 3/048

(52) U.S. Cl. 707/710; 715/760; 707/706; 707/E17.014; 715/205; 707/E17.032

(57) ABSTRACT

The present invention provides an (online) web application that mimics the Google® search engine on the web. Because of copyright laws, it is illegal to copy web articles their content and place them in a web application or database unless you have permission from the copyright owner.

The invention is to implement a web application with a database that solely contains the articles metadata (such as title, category, hyperlink) and that uses the (hidden) hyperlinks to open the articles content in a web browser when the user (double)-clicks the article from the grid in the web application.

As a result, no copyright infringement is possible and the web application and its database can be updated (automatically) with updated articles. There is also an (intelligent) search or filter possibility so users can easily search or filter through all the articles from within the web application prior from visiting them.

### CROSS REFERENCE TO RELATED APPLICATIONS

This application is a division and claims the priority benefit of U.S. patent application Ser. No. 12/614,394 filed Nov. 7, 2009, and entitled “System, Method and Software Application for Implementing a Google-like Search in a Software,” the disclosure of which is incorporated herein by reference for all purposes.

### FIELD OF THE INVENTION

This invention relates generally to web applications that use an (intelligently) searchable database of articles metadata with (hidden) hyperlinks and use a web browser to view the articles content on the same or on third party websites.

### DESCRIPTION OF THE BACKGROUND ART

It is very useful to create a web application with a database that allows users to search and filter web articles instead of simply using standard hyperlinks. The web application could for instance be a tax web application with web articles viewed in a grid that is fully searchable, with all its metadata in place, (such as title, category) and whereby the user can decide if he/she opens the web article in a web browser. The result is that the owner of the web application is not required to have a copyright license for each article that is contained in the database, thus allowing the web application owner to freely implement his/her database, same as in the Google® search engine from Google, Inc. of Mountain View, Calif., you search the web articles through their metadata. Hereby, a knowledge/expert database of articles can be implemented on any matter and a much more powerful search can be implemented than via/through a search engine like the Google® search engine.

### SUMMARY

The present invention provides an (online) web application that mimics the Google® search engine on the web.

Because of copyright laws, it is illegal to copy web articles their content and place them in a web application or database unless you have permission from the copyright owner.

The invention is to implement a web application with a database that solely contains the articles metadata (such as title, category, hyperlink) and that uses the (hidden) hyperlinks to open the articles content in a web browser when the user (double)-clicks the article from the grid in the web application.

As a result, no copyright infringement is possible and the web application and its database can be updated (automatically) with updated articles. There is also an (intelligent) search or filter possibility so users can easily search or filter through all the articles from within the web application prior from visiting them.

### DETAILED DESCRIPTION OF THE PREFERRED EMBODIMENTS

The present invention provides an (online) web application that mimics the Google® search engine on the web.

Because of copyright laws, it is illegal to copy web articles their content and place them in a web application or database unless you have permission from the copyright owner.

The invention is to implement a web application with a database that solely contains the article metadata (such as title, category, hyperlink) and that uses the (hidden) hyperlinks to open the article content in a web browser when the user (double)-clicks the article from the grid in the web application.

As a result, no copyright infringement is possible, and the web application and its database can be updated (automatically) with updated articles. There is also an (intelligent) search or filter possibility so users can easily search or filter through all the articles from within the web application prior from visiting them.

It is also possible that instead of a web article, a file on the web gets opened directly (for instance an Adobe pdf file gets downloaded from a third-party website).

The metadata or data that corresponds with each article in the database can contain all kinds of information about the articles such as category, title, etc.

The hyperlink can be visible or invisible, it does not need to be a hyperlink by definition, it could as well be a link/web address of any kind.

It is also possible that the articles (and their contents) are also implemented in the web application itself instead of on a third party (web)server, as such the metadata can include the content as well (for instance, some articles are pdf-based and are located in the web application itself)

An (intelligent) search or filter can be implemented in the database or web application thus to help the users easily find the articles.

There can be an (automatic) update functionality for instance, whereby the articles data and/or its hyperlinks are updated. For instance, the web application has an auto-update feature to update and/or create/remove articles (data) from the database or web application.

The implemented grid, table or other method to view the articles allows the user to open the file/article in any way possible (such as by double-clicking the article data of the grid, the web-based article opens up in a web-browser).

The users can also score, comment, or give any ratings to the articles in any way possible (such as comment on articles in an online forum).

The users can (automatically) add/remove/update articles metadata in any way possible (for instance, a CPA or tax adviser adds a tax article metadata (including hyperlink) to the database by sending the article metadata to a web server, whereby upon approval by an administrator it is transmitted to the users of the web application and automatically updated in the database).

The client/server database and/or its representation (such as through a grid) can be of any form and implemented in any way possible (such as like an HTML-enabled table and article)

The web application and/or database are internet/web-based in any way possible. (For instance, the web application is in the form of a Java application or HTML application that is implemented on a webserver and the database is also implemented on a webserver and an internet-based search on the articles metadata in an (online) grid of any kind is possible)

Any implementation for an offline/online articles search engine of any kind implemented with a searchable grid of any kind (with articles metadata) that opens up (web) articles in the same/another web browser of any kind with/through its (hidden) hyperlinks is claimed

An implementation for an online search engine (such as Google® search engine) that uses/implements this technology is also possible (For instance, whereby the user uses a keyword search in Google® and gets into an (intelligently) searchable web/internet enabled articles database with metadata and hyperlinks and thus for example provide a much more powerful online search by using an online expert database of articles that are implemented by other users/market participants and are updated regularly/automatically)

What is claimed is:

1. An (online) web application of any kind which contains/uses a (server/client) database of any kind
And whereby a list of web-based articles metadata of any kind are implemented in its database with/by/through (hidden) hyperlinks of any kind
And whereby the web-based articles themselves, their content, are not residing in the web application itself, but on a third party (web)server of any kind in any way possible
And whereby a user can see, search or filter the web-based articles (meta)data (such as title, category, others) in the web application in any way possible (such as in an online grid) and can also, through its (hidden) hyperlink, open the desired website article and view its content in the same/another web browser of any kind

2. An (online) web application of claim 1 wherein the (hidden) hyperlinks in the database or web application opens up a file on the web of any kind (for instance, opening an Adobe pdf file, Word file, Powerpoint file)

3. An (online) web application of claim 1 wherein the database or web application with (hidden) hyperlinks contain any kind of information/(meta)data about the articles (for instance, titles, categories, or others)

4. An (online) web application of claim 1 wherein articles (and their contents) are also implemented in the web application itself instead of on a third party (web)server, as such the metadata can include the content as well (for instance, some articles are pdf-based and are located in the web application itself)

5. An (online) web application of claim 1 wherein there is a (intelligent) search or filter possibility of any kind implemented in the web application

6. An (online) web application of claim 1 wherein the articles metadata, including the (hidden) hyperlinks, are (automatically) updated in any way possible. (For instance, the web application has an auto-update feature to update and/or create/remove articles metadata from the database or web application)

7. An (online) web application of claim 1 wherein there is a grid of any kind that shows the articles metadata in the database or web application so the user can open the (hyperlinked) file/article in any way possible (such as by double-clicking the article metadata of the grid, the web-based article opens up in a web-browser on the same webpage or on another webpage)

8. An (online) web application of claim 1 wherein an (intelligently) searchable web application with articles metadata is implemented with (hidden) hyperlinks that uses a webbrowser to view the articles content upon a user his/her request

9. An (online) web application of claim 1 wherein the users scores, comments or gives any ratings to the articles metadata in any way possible (such as comment on articles in an online forum)

10. An (online) web application of claim 1 wherein the users (automatically) add/remove/update articles metadata in any way possible (For instance, a CPA or tax adviser adds a tax article to the database by sending the article metadata with hyperlink to a webserver whereby upon approval by an administrator it is transmitted to the users of the web application and automatically updated in their databases)

11. An (online) web application of claim 1 wherein the database and/or its representation (such as through a grid) is of any form and implemented in any way possible (such as like an HTML-enabled table and article)

12. An (online) web application of claim 1 wherein the web application and/or database are internet/web-based in any way possible. (For instance, the web application is in the form of a Java application or HTML application that is implemented on a webserver and the database is also implemented on a webserver and an internet-based search on the articles metadata in an (online) grid of any kind is possible)

13. An (online) web application of claim 1 wherein an offline/online search engine of any kind is implemented with a searchable grid of any kind (with articles metadata) that opens up (web) articles in the same/another web browser of any kind with/through its (hidden) hyperlinks

14. An (online) web application of claim 1 wherein an online search engine (such as Google® search engine) uses/implements an internet/web-based application as claimed in claims 1, 2, 3, 4, 5, 6, 7, 8, 9, 10, 11, 12, 13. (For instance, whereby the user uses a keyword search in Google® and gets into an (intelligently) searchable web/internet enabled articles database with metadata and hyperlinks and thus for example provide a much more powerful online search by using an online expert database of articles that are implemented by other users/market participants and are updated regularly/automatically)

15. An (online) web application of claims 1, 2, 3, 4, 5, 6, 7, 8, 9, 10, 11, 12, 13, 14 wherein the (hidden) hyperlink is a (hidden) link and/or web address of any kind, it does not need to be a hyperlink by definition

16. An (online) web application of claims 1, 2, 3, 4, 5, 6, 7, 8, 9, 10, 11, 12, 13, 14 wherein the data or metadata is of any form possible (such as title, category, hyperlink, external data, searching/classification data), it does not limit itself to the article (meta)data itself

17. An (online) web application of claims 1, 2, 3, 4, 5, 6, 7, 8, 9, 10, 11, 12, 13, 14 wherein the articles are web articles of any kind or webfiles of any kind or implemented in the web application in any way possible (such as an html page, php page, other pages on a webserver, or as files such as an (online) pdf file, or part of the web application)
